(19) United States
(12) Patent Application Publication
(10) Pub. No.: US 2011/0052115 A1
(43) Pub. Date: Mar. 3, 2011

(54) SYSTEM AND METHOD FOR TEMPERATURE CONTROL AND COMPENSATION FOR FIBER OPTIC CURRENT SENSING SYSTEMS

(75) Inventors: Boon Kwee Lee, Clifton Park, NY (US); Renato Guida, Wynantskill, NY (US); Juntao Wu, Niskayuna, NY (US); Sebastian Gerhard Maxim Kraemer, Muenchen (DE); Sachin Narahari Dekate, Niskayuna, NY (US)

(73) Assignee: GENERAL ELECTRIC COMPANY, SCHENECTADY, NY (US)

(21) Appl. No.: 12/548,512

(22) Filed: Aug. 27, 2009

(51) Int. Cl. G02B 6/00; G01B 9/02; G01J 3/44

(52) U.S. Cl. 385/12; 356/483; 356/301; 356/519

(57) ABSTRACT

A fiber optic sensor system employs at least one light source that operates to generate light having one or more desired wavelengths. A first optical fiber based sensor transparent to a desired light wavelength operates to sense a magnetic field emitted from a predetermined electrical conductor or a current flowing through the electrical conductor. A temperature sensor that may be another optical fiber based sensor operates to sense an operating temperature associated with the first optical fiber based sensor in response to the light generated by the light source. Signal-processing electronics adjust the sensed current to substantially compensate for temperature induced errors associated with the sensed current in response to the measured operational temperature of the fiber optic sensor.

### BACKGROUND

This invention relates generally to fiber optic sensing methods and systems, and more particularly, to a fiber optic system and method for compensating temperature induced errors associated with optical current sensor measurements.

Fiber optic magnetic field or current sensing is strongly temperature dependent. Due to this temperature dependence, such sensing techniques require temperature isolation or temperature measurements and compensation techniques.

A common principle, applied in state-of-the-art systems is to use metal-wire-bounded thermo elements to measure the temperature. Metal-wire-bounded thermo elements cannot always be employed in electromagnetically harsh environments. Other techniques include self-compensation for temperature during current sensing but these techniques are effective in a limited temperature range or require complicated signal-processing algorithms.

Fiber optic temperature sensors are better suited for use in electromagnetically harsh environments due to their intrinsic immunity to external electromagnetic fields and have a large measureable temperature range.

A fiber optic temperature sensing system along with the fiber optic current sensing system would be simpler to implement since both sensing systems are based on the fiber optic sensor platform.

### BRIEF DESCRIPTION

Briefly, in accordance with one embodiment, a temperature compensated fiber optic current sensing system comprises:

a fiber optic transducer configured to sense current flowing through an electrical conductor;

a fiber optic temperature sensor configured to measure the operational temperature of the fiber optic sensor; and

signal-processing electronics configured to adjust the sensed current measurement to substantially compensate for temperature induced errors associated with the sensed current in response to the measured operational temperature of the fiber optic current transducer.

### DRAWINGS

These and other features, aspects, and advantages of the present invention will become better understood when the following detailed description is read with reference to the accompanying drawings in which like characters represent like parts throughout the drawings, wherein:

FIG. 1 illustrates the temperature dependence of measured current using a fiber optic current sensing system;

FIG. 2 is a flowchart showing a method of providing a temperature compensated current measurement according to one embodiment of the present invention;

FIG. 3 is a simplified diagram illustrating a temperature compensated fiber optic current sensing system using a single point fiber optic temperature sensor according to one embodiment of the present invention;

FIG. 4 is a simplified diagram illustrating a temperature compensated fiber optic current sensing system using a series configuration of fiber optic temperature sensors according to one embodiment of the present invention;

FIG. 5 is a simplified diagram illustrating a temperature compensated fiber optic current sensing system using one or more continuous distributed fiber optic temperature sensing elements according to one embodiment of the present invention;

FIG. 6 is a simplified diagram illustrating a temperature compensated fiber optic current sensing system using a parallel configuration of fiber optic temperature sensors according to one embodiment of the present invention;

FIG. 7 is a simplified diagram illustrating a temperature controller responsive to a temperature compensated fiber optic current sensing system according to one embodiment of the present invention;

FIG. 8 is a simplified schematic illustrating a temperature compensated fiber optic current sensing system using multiple light sources and multiple photo-detectors combined with a fiber optic current transducer and a separate fiber optic temperature sensor according to one embodiment of the present invention;

FIG. 9 is a simplified schematic illustrating a temperature compensated fiber optic current sensing system using multiple light sources and multiple photo-detectors in combination with a fiber optic current transducer and a fiber optic temperature sensor that are both integrated with a common optical fiber according to one embodiment of the present invention;

FIG. 10 is a simplified schematic illustrating a temperature compensated fiber optic current sensing system using a common light source and a common photo-detector combined with a fiber optic current transducer and a separate fiber optic temperature sensor according to one embodiment of the present invention;

FIG. 11 is a simplified schematic illustrating a temperature compensated fiber optic current sensing system using a common light source and common photo-detector in combination with a fiber optic current transducer and a fiber optic temperature sensor that are both integrated with a common optical fiber and driving a common detector unit according to another embodiment of the present invention;

FIG. 12 is a simplified schematic illustrating a temperature compensated fiber optic current sensing system using a common light source in combination with a fiber optic current transducer and a fiber optic temperature sensor that may or may not be integrated with a common optical fiber and driving corresponding detectors according to one embodiment of the present invention;

FIG. 13 is a simplified schematic illustrating a temperature compensated fiber optic current sensing system using multiple light sources in combination with a fiber optic current transducer and a fiber optic temperature sensor that may or may not be integrated with a common optical fiber and a common detector according to one embodiment of the present invention;

FIG. 14 depicts a physical temperature compensated fiber optic current sensing system using one or multiple fiber Bragg grating sensors to implement fiber optic temperature sensors and fiber optic current transducer to measure current based on Faraday effect, corresponding to system architecture represented by FIGS. 4 and 8; and

FIG. 15 depicts a physical temperature compensated fiber optic current sensing system using Gallium-Arsenide material (GaAs) optical reflectivity based fiber temperature sensing technology and discrete Faraday Garnet crystal based current sensing technology to implement a system architecture represented by FIGS. 3 and 8.

While the above-identified drawing figures set forth alternative embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

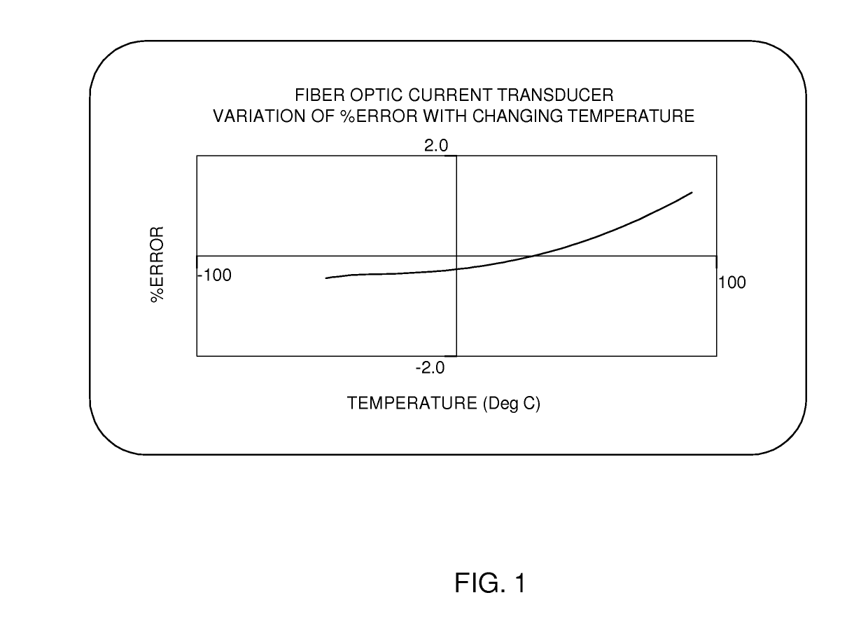

Embodiments of the invention described herein with reference to FIGS. 1-15 are directed to a temperature compensated fiber optic sensor system for magnetic field or current sensing. Particular embodied magnetic field or current sensors described herein are based on the Faraday effect in optical materials such as an optical fiber core or a Faraday garnet. More specifically, these embodiments are based on polarimetric sensing principles where the angle of polarized light rotates with respect to the strength of a magnetic field generated by current flow.

The embodied fiber optic temperature sensors described herein employ intrinsic and/or extrinsic fiber optic sensing methods that may include, without limitation, fiber Bragg grating measurements, Raman scattering, Brillouin scattering, Fabry-Perot interferometric measurements, Mach-Zehnder interferometric measurements, Michelson interferometric measurements, Sagnac interferometric measurements, microbending measurements, macrobending measurements, polarimetric measurements, pyrometric measurements, reflectivity measurements, and emissivity measurements. The location of the temperature sensor points can be separate from or co-located with an optical magnetic/current sensor such as a magnetic field sensitive optical fiber or Faraday garnet.

Combining both fiber optic magnetic field/current sensors and fiber optic temperature sensors on one optical fiber according to one embodiment, provides a cost effective system that can be manufactured with enhanced performance. Since the Faraday effect is strongly temperature dependent, the measured temperature can be used to compensate for any temperature-induced error in the current/magnetic field measurements.

FIG. 1 illustrates the variability of the current measurement with changing temperature. The figure shows the non-linear characteristics of the temperature dependence. A fiber optic current transducer system that operates in an extended temperature zone has to be compensated for this temperature-induced error.

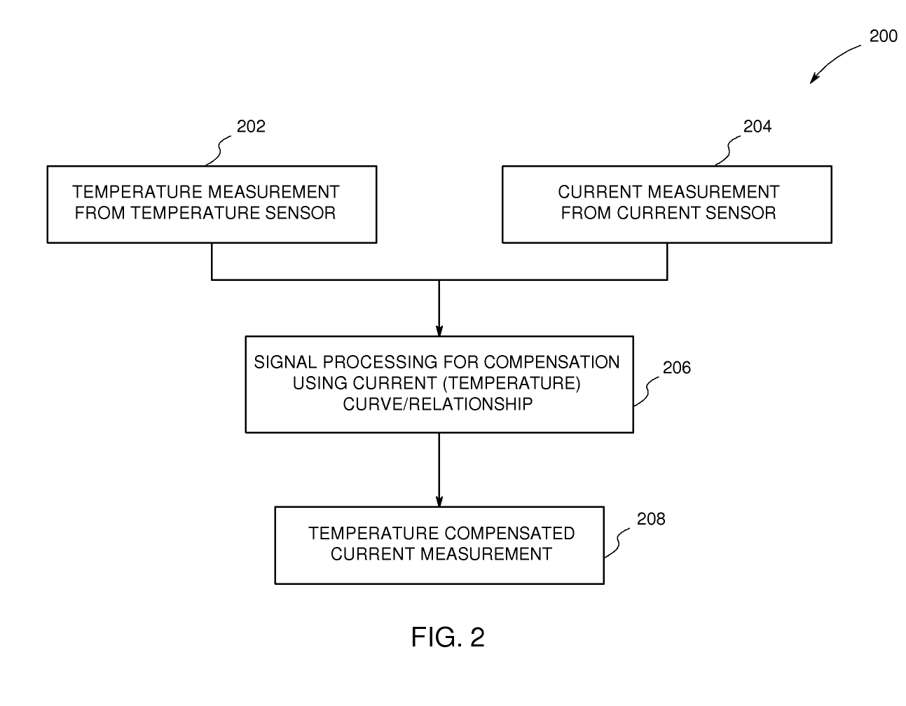

FIG. 2 identifies the functional blocks in order to implement a temperature compensated fiber optic current transducer. Temperature measurement 202, along with the current measurement 204 is fed into a signal processor 206. The signal processor 206 uses these two inputs to produce a more accurate current measurement 208 that does not include errors induced by temperature.

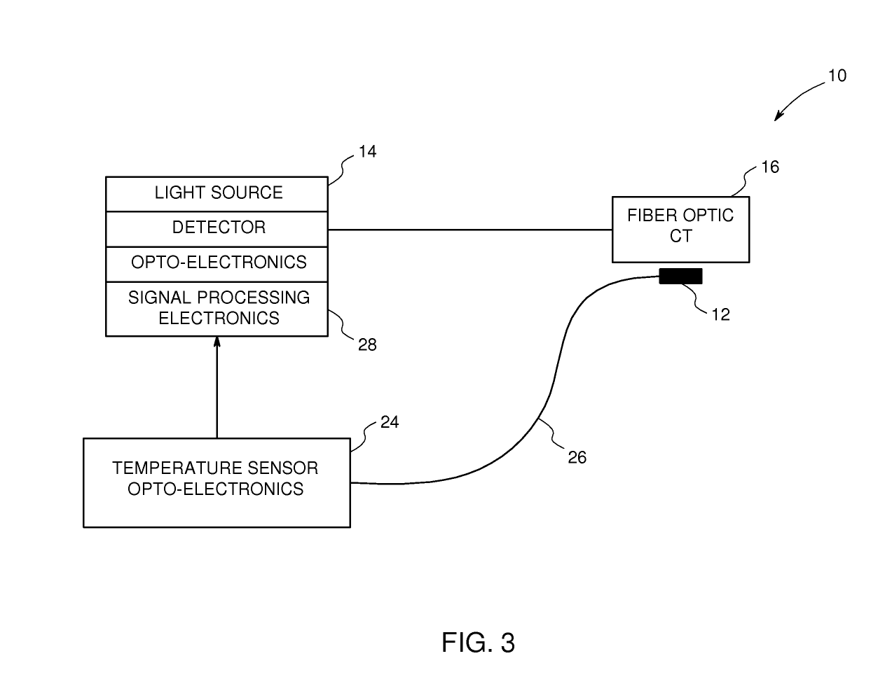

FIG. 3 is a simplified diagram that illustrates a temperature compensated fiber optic current sensing system 10 using a single point fiber optic temperature sensor 12 according to one embodiment of the present invention. Fiber optic current sensing system 10 can be seen to include a light source 14 that can be a laser light or a broadband light source according to particular embodiments. Fiber optic current sensing system 10 also includes a fiber optic current transducer 16 that may operate using the Faraday effect.

Fiber optic temperature sensor 12 may be independent from optic fiber current transducer 16 according to one embodiment. According to one aspect, temperature sensor 12 may comprise, for example, Gallium-Arsenide material (GaAs), which is optically transparent at light wavelengths above about 850 nm due to its material band edge. The position of this band edge is temperature dependent and shifts approximately 0.4 nm per degree Kelvin. This information is transmitted to corresponding temperature sensor opto-electronics 24 along an optical fiber 26. The temperature information is then transmitted to signal-processing electronics 28 that may be, for example, a digital signal processor (DSP). The signal-processing electronics 28 processes the measured current signals generated via the current transducer 16 along with the measured temperature signals generated via the temperature sensor 12, to generate a temperature compensated current signal measurement. Fiber optic temperature sensor 12 may comprise a desired portion of the optical fiber 26 according to another embodiment, wherein the desired portion includes, for example, one or more fiber sensors.

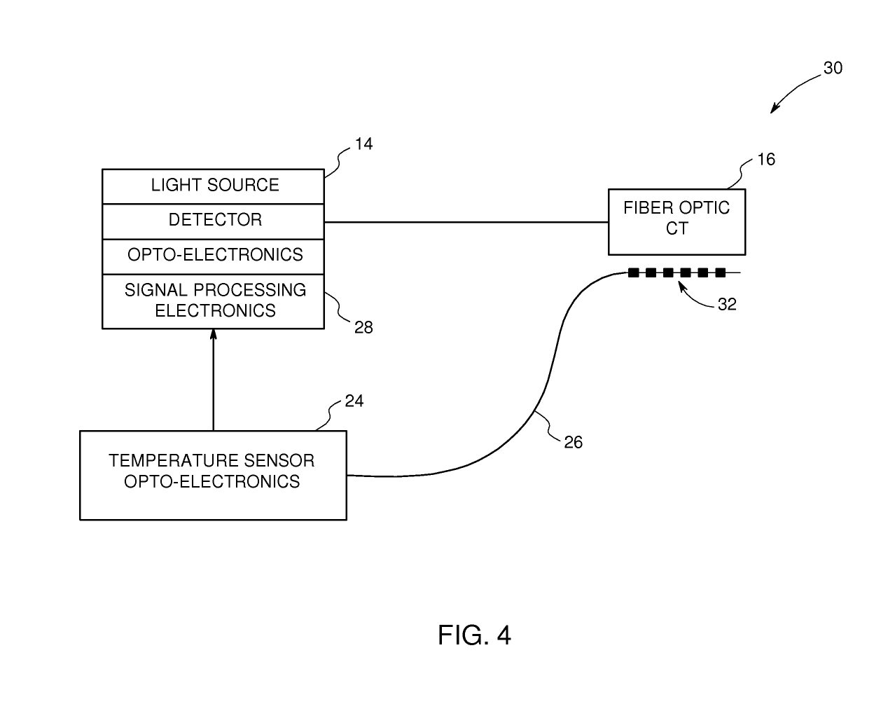

FIG. 4 is a simplified diagram illustrating a temperature compensated fiber optic current sensing system 30 using a series configuration of temperature sensors 32 according to one embodiment of the present invention. Fiber optic current sensing system includes a light source 14 that is a laser light source according to one embodiment or a broadband light source according to another embodiment, and further includes a fiber optic current transducer 16 that may operate using the Faraday effect.

According to one embodiment, temperature sensors 32 comprise multiple fiber sensors, intrinsic or extrinsic, at discrete points in or along the optical fiber 26. The properties of light passing through the fiber sensors are temperature dependent in well-known fashion; and so operating principles of fiber temperature sensors are not discussed further herein to preserve brevity and enhance clarity in better understanding the principles described herein. Light signals generated via temperature sensors 32 are transmitted to corresponding temperature sensor opto-electronics 24 along optical fiber 26. The temperature information is then transmitted to signal-processing electronics 28 that may include, for example, and without limitation, a digital signal processor (DSP). The signal-processing electronics 28 processes the current signals generated via the fiber optic current transducer 16 along with the temperature signals generated via the plurality of fiber optic temperature sensors 32 to generate a temperature compensated current measurement signal.

FIG. 5 is a simplified diagram illustrating a temperature compensated fiber optic current sensing system 190 using one or more continuous distributed temperature sensors 192 according to one embodiment of the present invention. Fiber optic current sensing system 190 functions in substantially the same fashion as temperature compensated fiber optic current sensing systems 10 and 30 described above, with the exception of using a continuous distributed temperature sensing configuration for measure and transmit temperature signals to corresponding temperature sensor opto-electronics 24.

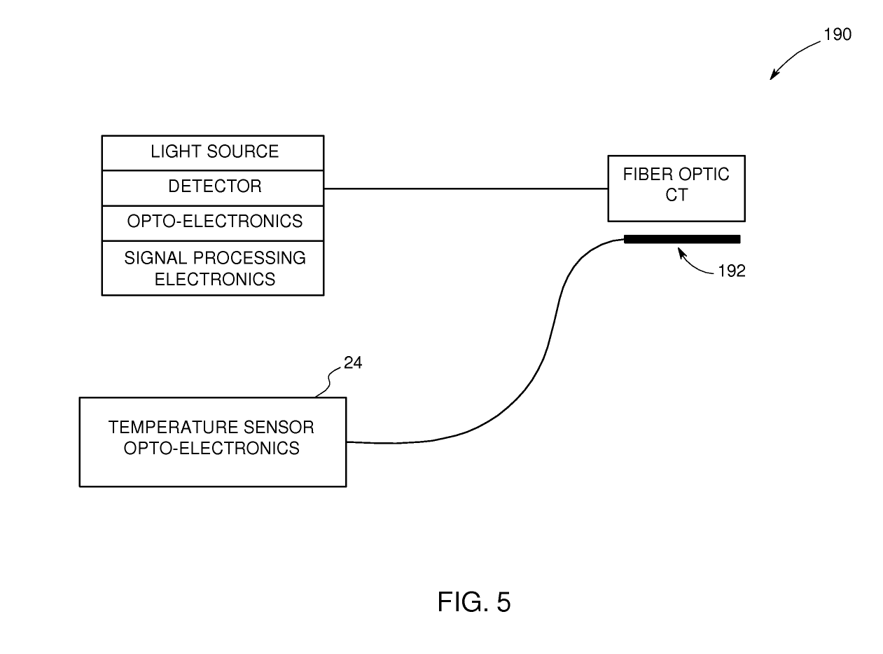

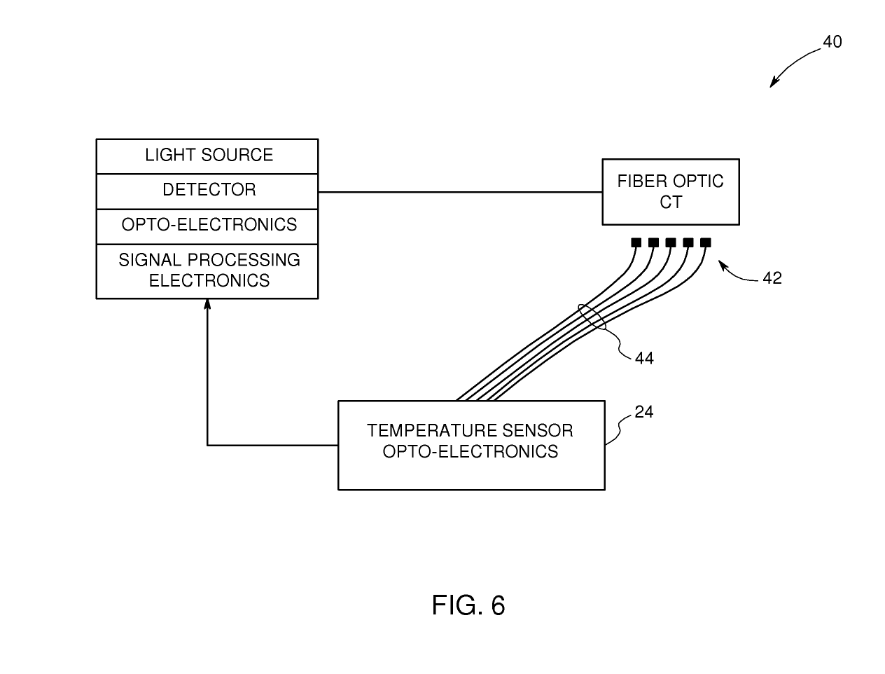

FIG. 6 is a simplified diagram illustrating a temperature compensated fiber optic current sensing system 40 using a parallel configuration of fiber optic temperature sensors 42 according to one embodiment of the present invention. Fiber optic current sensing system 40 functions in substantially the same fashion as temperature compensated fiber optic current sensing systems 10 and 30 described above, with the exception of using a parallel configuration of fiber optic temperature sensors 42 and a plurality of corresponding optic fibers 44 that provide a communication path for transmitting temperature signals to corresponding temperature sensor opto-electronics 24.

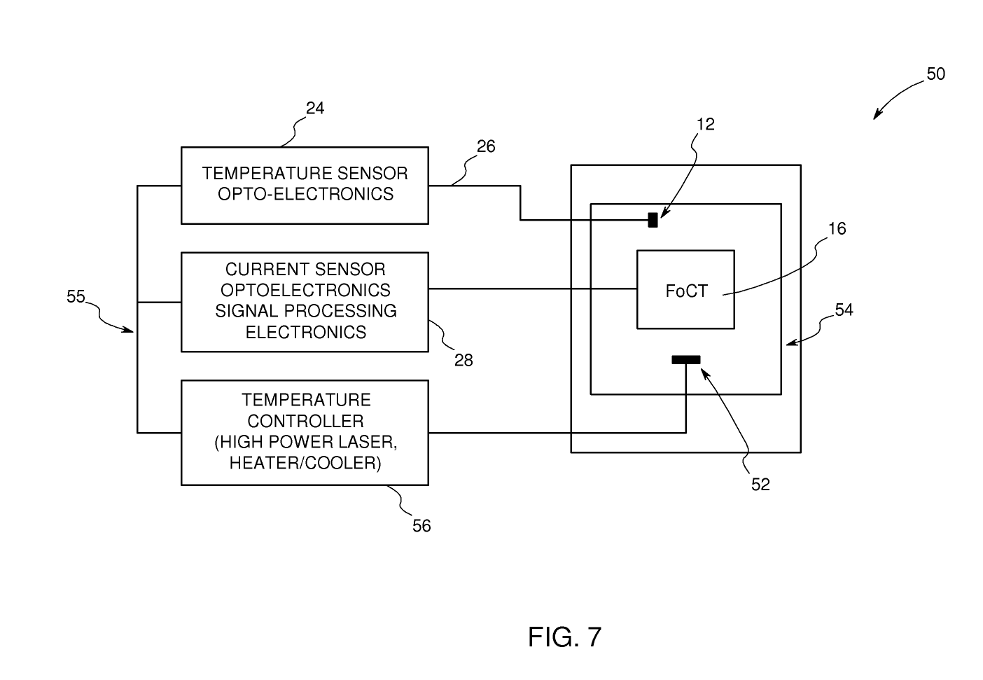

FIG. 7 is a simplified diagram illustrating a temperature compensated fiber optic current sensing system 50 has a temperature controller 56, that is responsive to temperature measured by temperature sensor 12 and temperature sensing electronics 24, according to one embodiment of the present invention.

According to one embodiment, the temperature sensor 12 measures the temperature and transmits the information via fiber optic cable 26 to temperature sensor opto-electronics 24 which yields a temperature measurement that can be used by a temperature controller 56 via a data communication link 55 to control a heating and or a cooling element 52. According to another embodiment the temperature measurement from temperature sensing opto-electronics 24 can simultaneously be used via data communication link 55 by the signal-processing electronics 28 that may include, for example, and without limitation, a digital signal processor (DSP) to yield a temperature compensated current measurement. This may be the case if the heating/cooling element is not fast enough or has limited heating/cooling capabilities.

According to one embodiment, a temperature controller 56 is electrically or optically coupled to a heating/cooling element 52 strategically placed in close proximity to the fiber optic current transducer 16 such that the heating/cooling element 52 can effectively heat and cool the fiber optic current transducer 16. Heating/cooling element 52 may also work in combination with an insulator element 54 to cool down or heat up the fiber optic current transducer 16. If the temperature controller 56 is electrically powered, the level of current passing through heating/cooling element 52 is therefore controlled in a manner that causes the fiber optic current transducer 16 to operate within a temperature stabilized operating environment.

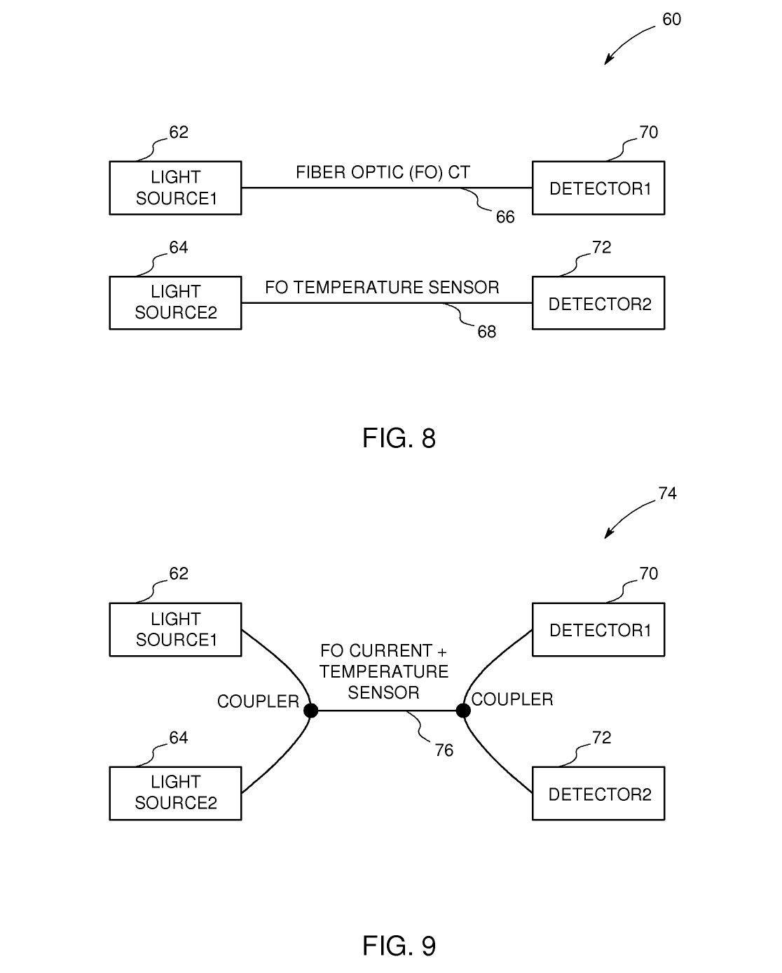

FIG. 8 is a simplified block diagram illustrating a temperature compensated fiber optic current sensing system 60 using multiple light sources 62, 64 transmitting light to a fiber optic current transducer 66 and a fiber optic temperature sensor 68 to generate current and temperature signals received by corresponding detectors 70, 72, according to one embodiment of the present invention.

FIG. 9 is a simplified block diagram illustrating a temperature compensated fiber optic current sensing system 74 using multiple light sources 62, 64 transmitting light to a fiber optic current and temperature sensor 76 to generate current and temperature signals received by multiple detectors 70, 72 according to one embodiment of the present invention. The current and temperature sensing elements 76 are integrated with an optical fiber common to both sensors.

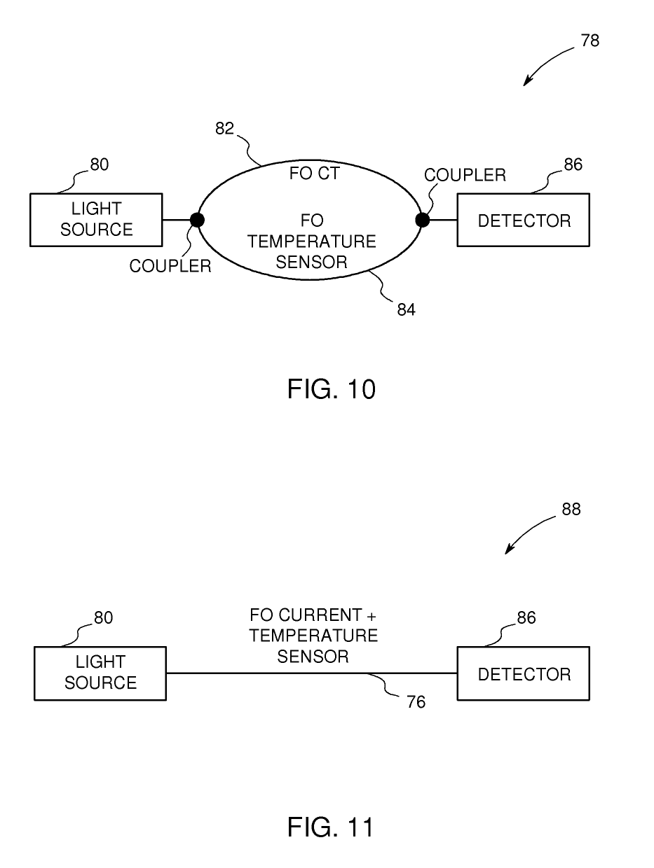

FIG. 10 is a simplified block diagram illustrating a temperature compensated fiber optic current sensing system 78 using a common light source 80 transmitting light to a fiber optic current transducer 82 and a fiber optic temperature sensor 84 to generate current and temperature signals received via a common detector 86 according to one embodiment of the present invention.

FIG. 11 is a simplified block diagram illustrating a temperature compensated fiber optic current sensing system 88 using a common light source 80 transmitting light to a fiber optic current and temperature sensor 76 to generate current and temperature signals received by a common detector 86 according to one embodiment of the present invention. The current and temperature sensing elements 76 are integrated with an optical fiber common to both sensors.

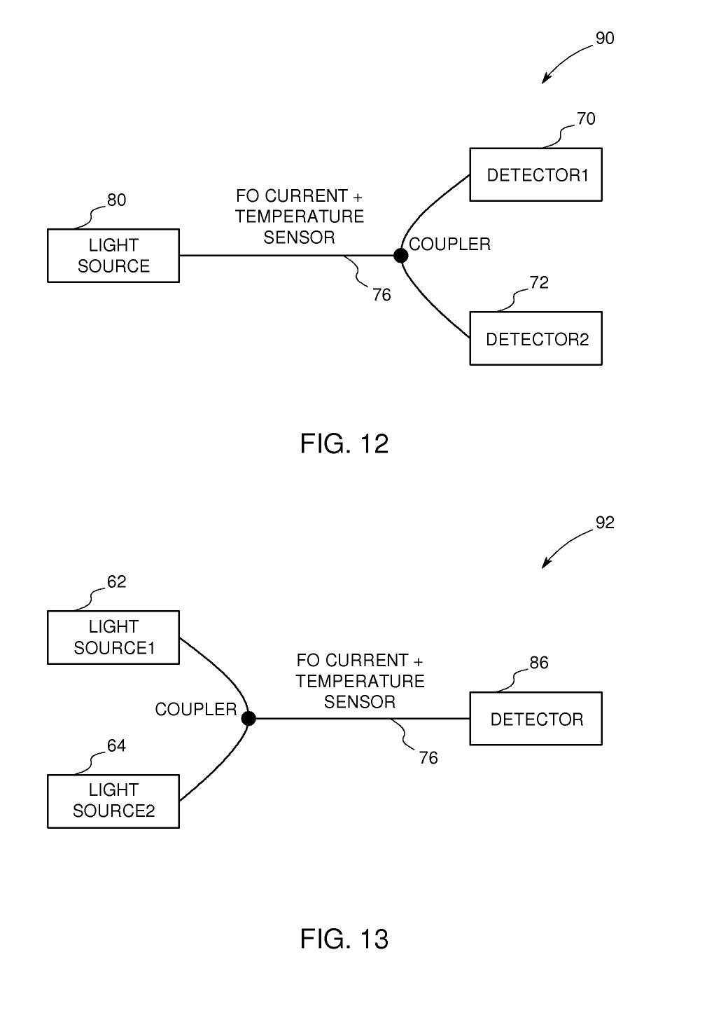

FIG. 12 is a simplified block diagram illustrating a temperature compensated fiber optic current sensing system 90 using a common light source 80 transmitting light to a fiber optic current and temperature sensor 76 to generate current and temperature signals received by and a plurality of detectors 70, 72 according to one embodiment of the present invention. The current and temperature sensing elements 76 are integrated with an optical fiber that may or may not be common to both sensors. Detector 70 operates to measure the current represented by the current signal, while detector 72 operates to measure the temperature represented by the temperature signal.

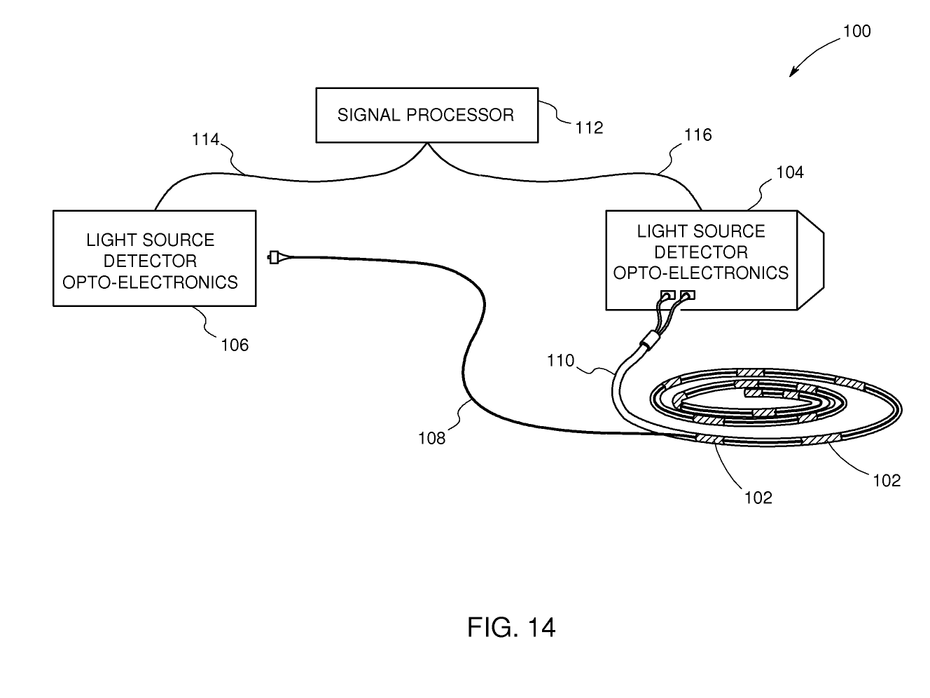

FIG. 13 is a simplified block diagram illustrating a temperature compensated fiber optic current sensing system 92 using multiple light sources 62, 64 transmitting light to a fiber optic current and temperature sensor 76 to generate current and temperature signals received by a common detector 86 according to one embodiment of the present invention. The current and temperature sensing elements 76 may or may not be integrated with an optical fiber common to both sensors. The fiber optic current transducer is responsive to light transmitted from light source 62, while the fiber optic temperature sensor is responsive to light transmitted from light source 64. Detector 86 operates to measure the current represented by the current signal and also to measure the temperature represented by the temperature signal. The embodiments described above with reference to FIGS. 1-13 are not so limited however; and it shall be understood that many other embodiments can be formulated using the inventive concepts and principles described herein.

FIG. 14 depicts a physical temperature compensated fiber optic current sensing system 100 according to one embodiment, using one or multiple fiber Bragg grating sensors 102 to implement fiber optic temperature sensors and fiber optic current transducer 110 to measure current based on Faraday effect, corresponding to system architecture represented by FIGS. 4 and 8. Fiber optic current transducer signals are transmitted along optical fiber 110 while fiber optic temperature signals are transmitted along optical fiber 108. Temperature sensor detector 106 receives temperature signals via optical fiber 108 while current sensor detector 104 receives current signals via a separate corresponding optical fiber 110. Detector unit 106 includes a light source for the fiber optic temperature sensor(s) while detector unit 104 includes a light source for the fiber optic current transducer(s). The signal-processing unit 112 receives temperature information from detector 106 via a data communication link 114 and the current information from detector 104 via a data communication link 116 to generate a temperature compensated current measurement.

Fiber optic current sensing system 100 is based on the Faraday effect, which is a magnetically induced birefringence and leads to the rotation of the plane of polarization of a traveling light wave. The Faraday effect can be observed in diamagnetic and paramagnetic material like optical fibers using either a polarimetric method to measure the rotation of a linear polarization or an interferometric method to measure the non-reciprocal phase shift.

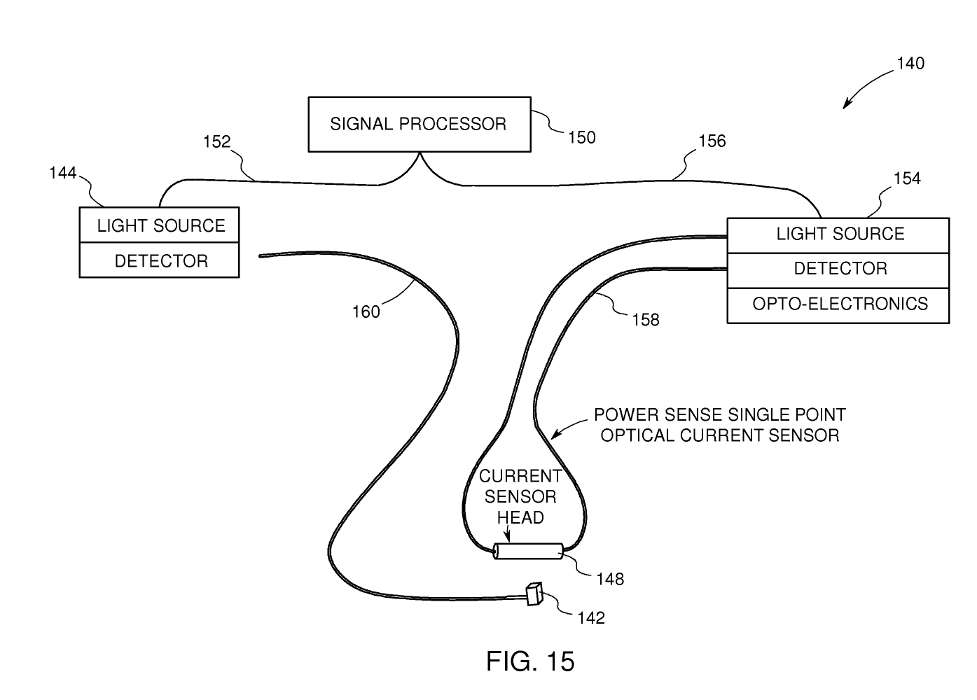

FIG. 15 depicts a physical temperature compensated fiber optic current sensing system 140 according to one embodiment, using Gallium-Arsenide material (GaAs) optical reflectivity based fiber temperature sensing technology to implement a system architecture represented by FIGS. 3 and 8. Fiber optic current sensing system 140 includes a GaAs chip 142 that operates to reflect signals in response to light generated by a light source 144. Fiber optic current transducer signals are transmitted along optical fiber 158 while fiber optic temperature signals are transmitted along optical fiber 160.

GaAs chip 142 comprises a direct band-edge material, which is optically transparent at light wavelengths above about 850 nm due to its internal material band edge. However, the position of this band edge is temperature dependent and shift about 0.4 nm per degree Kelvin. Other materials that may be used as direct band edge temperature sensors include without limitation, type III-V and type II-VI materials. Type III-V materials may include, for example, Gallium Arsenide, Indium Phosphide, Gallium Phosphide, Gallium Nitride, Aluminum Nitride, Indium Gallium Phosphide, Gallium Arsenide Phosphide, Indium Phosphide Arsenide, Aluminum Gallium Arsenide, Gallium Indium Arsenide Phosphide and Indium Arsenide. Type II-VI materials may include, for example, Zinc Telluride, Cadmium Sulphide, Cadmium Telluride, Cadmium Selenide, Zinc Selenide, Zinc Sulphide Selenide, Zinc Cadmium Sulphide, Zinc Oxide, Indium Selenide and Zinc Sulphide.

The current transducer head 148 comprises small crystal faraday garnet material exhibiting magneto optic sensitivity (high Verdet constant) that is at least an order of magnitude higher than those of typical paramagnetic and diamagnetic optical fiber based materials. Sensor head 148 measures the current based on the Faraday effect, which is a magnetically induced birefringence and leads to the rotation of the plane of polarization of a traveling light wave transmitted through the faraday garnet. A signal-processing unit 150 receives temperature information from detector 144 via data communication link 152 and the current information from detector 154 via data communication link 156 to generate a temperature compensated current measurement.

Current and temperature information can be simultaneously determined by incorporating an optical fiber temperature sensing element directly into the fiber optic current sensing system, by placing the optical fiber temperature sensing element in the proximity of the Faraday crystal garnet, or along side of the optical fiber. The resultant integrated system will share many similar optical components, thus reducing the cost and size of a fiber optic sensor system.

In summary explanation, a temperature compensated fiber optic current sensing system combines magnetic field or current sensing and temperature sensing to compensate temperature sensitive current measurements. According to one embodiment, the magnetic field or current transducer is based on the Faraday effect in optical materials such as diamagnetic and/or paramagnetic optical fiber cores or ferromagnetic garnets. According to one aspect, the sensor system employs polarimetric sensing principles where the angle of polarized light rotates with respect to the strength of a magnetic field or current flow. The sensor system further employs temperature sensing based on one or more intrinsic and extrinsic fiber optic sensing methods. The optical fiber temperature sensing methods and/or elements can include, without limitation, measurements based on measurement techniques selected from fiber Bragg grating measurements, Raman scattering, Brillouin scattering, Fabry-Perot interferometric measurements, Mach-Zehnder interferometric measurements, Michelson interferometric measurements, Sagnac interferometric measurements, microbending measurements, macrobending measurements, polarimetric measurements, pyrometric measurements, reflectivity measurements, and emissivity measurements.

Combining both sensors on one fiber provides a cost effective system. Since the Faraday effect is strongly temperature dependent, the measured temperature can be used to calibrate in real-time the current/magnetic field measurements. The location of the temperature sensor points can be at separate optical components or can be combined along with the optical magnetic field and current transducer such as magnetic field sensitive optical fiber or Faraday garnet(s).

While only certain features of the invention have been illustrated and described herein, many modifications and changes will occur to those skilled in the art. It is, therefore, to be understood that the appended claims are intended to cover all such modifications and changes as fall within the true spirit of the invention.

1. A fiber optic current sensing system comprising:
a fiber optic current transducer configured to sense a current flowing through an electrical conductor;
a temperature sensor configured to measure the operational temperature of the fiber optic current transduer; and
signal-processing electronics configured to adjust the sensed current measurement to substantially compensate for temperature induced errors associated with the sensed current measurement in response to the measured operational temperature of the fiber optic current transducer.

2. The fiber optic current sensing system according to claim 1, wherein the temperature sensor is configured to measure temperature at one or more discrete points along an optic fiber path.

3. The fiber optic current sensing system according to claim 1, wherein the temperature sensor is configured to measure temperature in a substantially continuous path along an optic fiber.

4. The fiber optic current sensing system according to claim 1, wherein the fiber optic temperature sensor measurements are based on measurement techniques selected from fiber Bragg grating measurements, Raman scattering, Brillouin scattering, Fabry-Perot interferometric measurements, Mach-Zehnder interferometric measurements, Michelson interferometric measurements, Sagnac interferometric measurements, microbending measurements, macrobending measurements, polarimetric measurements, pyrometric measurements, reflectivity measurements, and emissivity measurements.

5. The fiber optic current sensing system according to claim 1, wherein the fiber optic current transducer and the temperature sensor are together configured to operate on a single common optic fiber.

6. The fiber optic current sensing system according to claim 1, wherein the fiber optic current transducer comprises a first optic fiber and the temperature sensor comprises a second optic fiber.

7. The fiber optic current sensing system according to claim 1, further comprising a light source common to both the fiber optic current transducer and the temperature sensor.

8. The fiber optic current sensing system according to claim 1, further comprising one or more photodetectors common to both the fiber optic current transducer and the temperature sensor.

9. The fiber optic current sensing system according to claim 1, further comprising at least one detector responsive to at least one light characteristic selected from light intensity, light polarization, light wavelength, and light phase, such that the at least one detector is configured in combination with the temperature sensor to measure the operational temperature.

10. The fiber optic current sensing system according to claim 1, wherein the temperature sensor comprises semiconductor material.

11. The fiber optic current sensing system according to claim 10, wherein the temperature sensor is further configured to measure temperature at one or more discrete points along an optic fiber path.

12. The fiber optic current sensing system according to claim 10, wherein the semiconductor material comprises a direct-band edge material.

13. The fiber optic current sensing system according to claim 12, wherein the direct-band edge material is selected from type III-V and type II-VI semiconductor materials.

14. The fiber optic current sensing system according to claim 1, wherein the temperature sensor is a fiber optic sensor.

15. The fiber optic current sensing system according to claim 1, further comprising a temperature control system.

16. The fiber optic current sensing system according to claim 15, wherein the temperature control system is a passive control system.

17. The fiber optic current sensing system according to claim 16, wherein the passive temperature control system comprises an insulator configured to reduce the effects of environmental temperature changes surrounding the fiber optic current transducer.

18. The fiber optic current sensing system according to claim 15, wherein the temperature control system comprises both active control mechanisms and passive control mechanisms to control the operational temperature.

19. The fiber optic current sensing system according to claim 15, wherein the temperature control system is an active control system.

20. The fiber optic current sensing system according to claim 19, wherein the active temperature control system operates to control the operational temperature by heating or cooling.

21. The fiber optic current sensing system according to claim 20, wherein the active temperature control system is powered by optically or electrically delivered power.
